(19) United States
(12) Patent Application Publication
(10) Pub. No.: US 2022/0295736 A1
(43) Pub. Date: Sep. 22, 2022

(54) Habitats for Living Creatures and Related Methods

(71) Applicant: Cobweb Castle LLC, Beaufort, SC (US)

(72) Inventor: Elliott Stanton, Beaufort, SC (US)

(73) Assignee: Cobweb Castle LLC, Beaufort, SC (US)

(21) Appl. No.: 17/655,168

(22) Filed: Mar. 16, 2022

Related U.S. Application Data
(60) Provisional application No. 63/200,589, filed on Mar. 16, 2021.
(60) Provisional application No. 63/202,627, filed on Jun. 17, 2021.
(60) Provisional application No. 63/260,960, filed on Sep. 7, 2021.

(51) Int. Cl. A01K 1/00

(52) U.S. Cl. CPC A01K 1/00; A01K 2227/706

(57) ABSTRACT

A habitat for living creatures includes a top member, side members, and a bottom member. In implementations a separation member separates the habitat into first and second compartments and a through hole provides access between the two. In implementations an opaque member or closure selectively prevents light from entering the second compartment or selectively prevents light from entering the habitat from one or more directions. In implementations a habitat may be installed through an open window and one or more closure members may be used to provide a seal between the window and the lower window frame or wall to the sides of the habitat (or a window screen may be included and an opening cut through it only at an opening of the habitat). Front and rear transparent closures may selectively keep creatures within the habitat and a rear opaque member may be selectively removed to view the creatures.

### CROSS REFERENCE TO RELATED APPLICATIONS

This document claims the benefit of the filing date of U.S. Provisional Patent Application No. 63/200,589, entitled “Habitats for Arachnids and Insects and Related Methods,” naming as first inventor Elliott Stanton, which was filed on Mar. 16, 2021 (hereinafter “the '589 application”), and also claims the benefit of the filing date of U.S. Provisional Patent Application No. 63/202,627, entitled “Habitats for Arachnids and Insects and Related Methods,” naming as first inventor Elliott Stanton, which was filed on Jun. 17, 2021 (hereinafter “the '627 application”), and also claims the benefit of the filing date of U.S. Provisional Patent Application No. 63/260,960, entitled “Habitats for Living Creatures and Related Methods,” naming as first inventor Elliott Stanton, which was filed on Sep. 17, 20217 (hereinafter “the '960 application”), the disclosures of each of which are hereby incorporated entirely herein by reference.

### BACKGROUND

### 1. Technical Field

Aspects of this document relate generally to habitats for living creatures.

### 2. Background Art

A variety of habitats for living creatures exist in the art, including for insects and the like, such as ant farms. Other habitats exist for non-insect creatures, such as tanks for fish or reptiles or the like. Such habitats are generally designed to prevent the living creatures from escaping the habitat or, in other words, to keep the living creature as a pet inside a house or other building while confining the living creature to the habitat.

### SUMMARY

Implementations of habitats for living creatures include a top member, side members, and a bottom member. In implementations a separation member separates the habitat into first and second compartments and a through hole provides access between the two. In implementations an opaque member or closure selectively prevents light from entering the second compartment or selectively prevents light from entering the habitat from one or more directions. In implementations a habitat may be installed through an open window and one or more closure members may be used to provide a seal between the window and the lower window frame or wall to the sides of the habitat (or a window screen may be included and an opening cut through it only at an opening of the habitat). Front and rear transparent closures may selectively keep creatures within the habitat and a rear opaque member may be selectively removed to view the creatures.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a front/side/top view of an implementation of a habitat for living creatures;

FIG. 2 is a rear/side/top view of the habitat of FIG. 1 with an opaque member removed;

FIG. 3 is a rear close-up view of portions of the habitat of FIG. 1;

FIG. 4 is a rear/side/top view of the habitat of FIG. 1 with an opaque closure being installed or removed;

FIG. 5 is front/top view of an implementation of a habitat for living creatures;

FIG. 6 is a rear/top view of the habitat of FIG. 5;

FIG. 7 is a side/top view of the habitat of FIG. 5;

FIG. 8 is a rear close-up view of the habitat of FIG. 5 with an opaque member rotated to a position exposing a second compartment;

FIG. 9 is a side top view of the habitat of FIG. 5 with a transparent cover of the habitat removed from a base of the habitat;

FIG. 10 is a side close-up view of a separation member and base of an implementation of a habitat for living creatures;

FIG. 11 is a front/top view of the separation member and base of FIG. 10;

FIG. 12 is a side/top view of the separation member and base of FIG. 10 with a transparent cover coupled with the base;

FIG. 13 is a front/side/top view of an implementation of a habitat for living creatures which includes the base, separation member and transparent cover of FIG. 12;

FIG. 14 is a side close-up view of a second compartment of the habitat of FIG. 13;

FIG. 15 is a partially see-through side view of an implementation of a habitat for living creatures installed in a window opening;

FIG. 16 is a front view of the habitat of FIG. 15 installed in the window opening;

FIG. 17 is a rear/top/side view of elements of the habitat of FIG. 15;

FIG. 18 is a rear/top/side view of the elements of FIG. 17 with an opaque member installed;

FIG. 19 is a front/side/top view of elements of the habitat of FIG. 15;

FIG. 20 is a rear/side/top view of elements of the habitat of FIG. 15; and

FIG. 21 is a front/side/top view of elements of the habitat of FIG. 15.

### DESCRIPTION

Implementations/embodiments disclosed herein (including those not expressly discussed in detail) are not limited to the particular components or procedures described herein. Additional or alternative components, assembly procedures, and/or methods of use consistent with the intended habitats for living creatures and related methods may be utilized in any implementation. This may include any materials, components, sub-components, methods, sub-methods, steps, and so forth.

Implementations of habitats for living creatures and related methods relate to habitats that are used to house arachnids, insects and other creatures and which include viewing members through which a user can view the arachnids/insects/creatures.

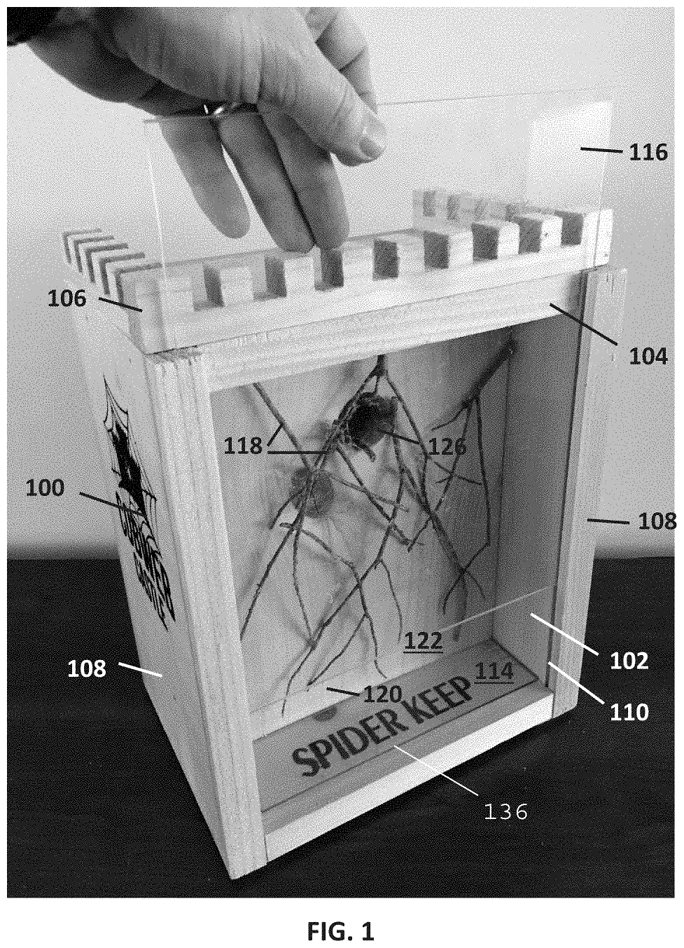

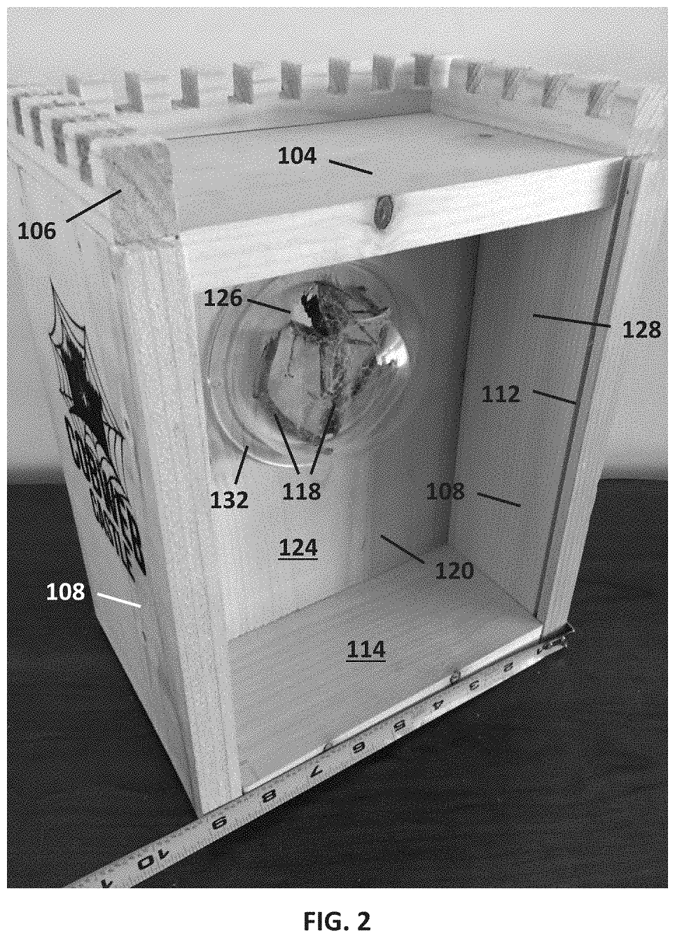

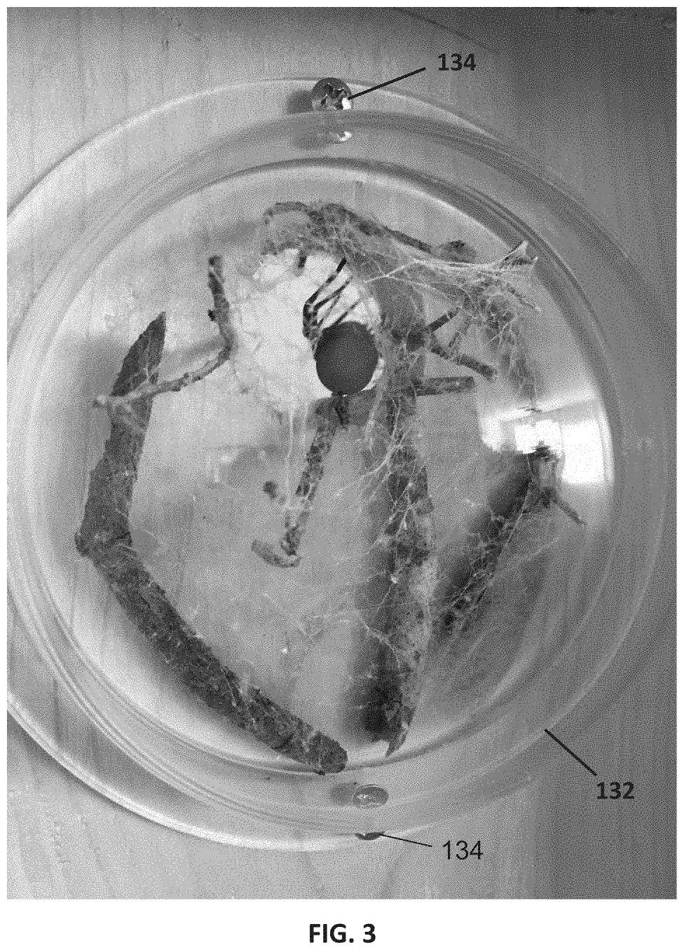

Referring now to FIGS. 1-4, an example habitat for living creatures (habitat) 100 is shown. Habitat 100 includes a top member 104, two side members 108, and a bottom member 114. The top member is attached to the two side members, which are in turn attached to the bottom member. In the example shown the top member, side members, and bottom member are formed of wood and are nailed, screwed and/or glued together, but in other examples they could be formed of other materials such as polymers, metals, composites, and so forth and could be coupled together using other coupling mechanisms such as magnets, a friction fit, and so forth. Battlements 106 are attached to the top member and provide an aesthetically pleasing look, creating the appearance of a castle. In the example shown in the figures the battlements are created of wood and are nailed, screwed and/or glued to the top member, though in other examples they could be formed of any of the other aforementioned materials used for the top/side/bottom members and could be coupled together using any of the above mentioned, or any other, coupling mechanisms. Additionally, in some cases one or more of the top member, bottom member, side members, battlements, and/or separation member with through hole (described below) could be integrally formed as one piece, such as with polymer molding techniques.

Separation member 120 separates the habitat into a first compartment (which could also be called a “keep” or “spider keep”) 102 and a second compartment 128. The separation member has a first surface 122 and an opposite second surface 124. A through hole 126 extends through the separation member, from the first surface 122 to the second surface 124. In the example shown in the drawings the separation member is wood and is nailed, screwed and/or glued to the side members and/or top member and/or bottom member or it may be slid into grooves (not shown) formed in the side members, bottom member and/or top member, to separate the habitat into the first compartment and second compartment. In other implementations the separation member could be formed of any other material, such as those disclosed above for other members, and could be coupled with other elements using any other coupling techniques, such as those disclosed above for other elements.

The side members include a pair of front grooves 110 which are used to receive a sliding transparent closure 116. The transparent closure slides into the grooves, as seen in FIG. 1, and rests against the bottom member to enclose the front of the first compartment. In implementations a front bottom groove in the bottom member could be included to receive the transparent closure. The front grooves are positioned so that, when the transparent closure is slid all the way down, the transparent closure prevents an insect or arachnid or other creature within the first compartment from exiting the first enclosure except through the through hole. The transparent closure is biased by gravity towards the closed configuration. A user can manually lift the transparent closure, however, as shown in FIG. 1, such as to insert food (which may be prey insects or the like) into the first enclosure for an arachnid or insect or other creature to eat. Additionally, the transparent closure may be opened to place an insect or arachnid or other creature in the habitat to begin with, or to remove the insect or arachnid or other creature, or to prepare or decorate the first compartment, and so forth.

The transparent closure may be formed of any transparent material, such as glass or a transparent polymer. In the examples shown in the drawings it is formed of a transparent acrylic. In the example shown in the drawings the transparent closure slides into grooves to enclose the first compartment, but in other implementations another closure mechanism could be used. For example, the transparent closure could be coupled to a side member, top member or bottom member using one or more hinges and a latch could be included to secure the transparent closure closed, or a magnetic attachment mechanism could be used to secure the transparent closure closed, instead of the grooves, and so forth.

A plurality of web attachment members 118 are shown in the first compartment (there are also web attachment members 118 within a cavity of transparent member 132—which transparent member will be discussed hereafter). The web attachment members are elements which an arachnid, such as a spider, may use as attachment points for webs and/or to hold onto while distributing webs. In the example shown in the drawings the web attachment members are actual sticks which are secured within the first compartment—such as attached to the separation member, or to a side member, top member or bottom member using an adhesive, nails, screws, or some other attachment mechanism. When the habitat is used to house a spider, the web attachment members may allow the spider to attach webs thereon, or may give the spider items to hold onto while stringing webs—the webs used for capturing prey and/or for other reasons. The web attachment members may also be used by an arachnid or non-arachnid creature to move about, hold onto and climb upon.

The second compartment 128 includes a transparent member 132 which is mated against the second surface 124. The transparent member could be secured to the separation member using a variety of techniques, such as using nails, an adhesive, screws, magnets, a friction fit, and so forth. The transparent member could also be formed or fashioned to include male screw threads, such as near an edge of the transparent member, and female threads could be included in the separation member (or vice-versa) to allow the transparent member to be secured to the separation member and removed therefrom using a screwing motion. Seals or the like could be included with or adjacent to the transparent member and/or transparent closure (for example to prevent very small, hatched spiders from escaping) so long as air flow is somehow allowed to permit the insects/arachnids to breathe. In the example shown in the drawings the transparent member includes a pair of openings that are used to secure the transparent member to the separation member using couplers 134. The couplers 134 in the example shown in the drawings are screws, but in other implementations they could be nails or any other coupling mechanism.

The transparent member could be formed of any transparent material, such as a glass or a transparent polymer. In the example shown it is formed of a transparent acrylic. The transparent member in the example shown is a semi-sphere (a 4-inch diameter transparent camera dome), but in other implementations it could be another shape, such as a cylinder or partial cylinder, a cube or partial cube, a cuboid or partial cuboid, an ellipsoid or partial ellipsoid, a cone or partial cone, and/or any other regular or irregular three-dimensional shape. In some cases the transparent member could simply be a flat transparent panel that fits into grooves or otherwise couples with the side members and/or top/bottom members and that is inset from an opaque closure (later discussed). In such an implementation a cavity is formed in the second compartment—the cavity formed by the transparent member, bottom member, side members, top member and separation member. In the example shown in the drawings, however, a cavity is formed by the transparent member and the second surface of the separation member. The cavity may also be called a “lair” of the arachnid or insect or other creature.

The through hole 126 allows an insect or arachnid or other creature to freely move back and forth as desired between the first compartment and the cavity formed by the transparent member and the separation member.

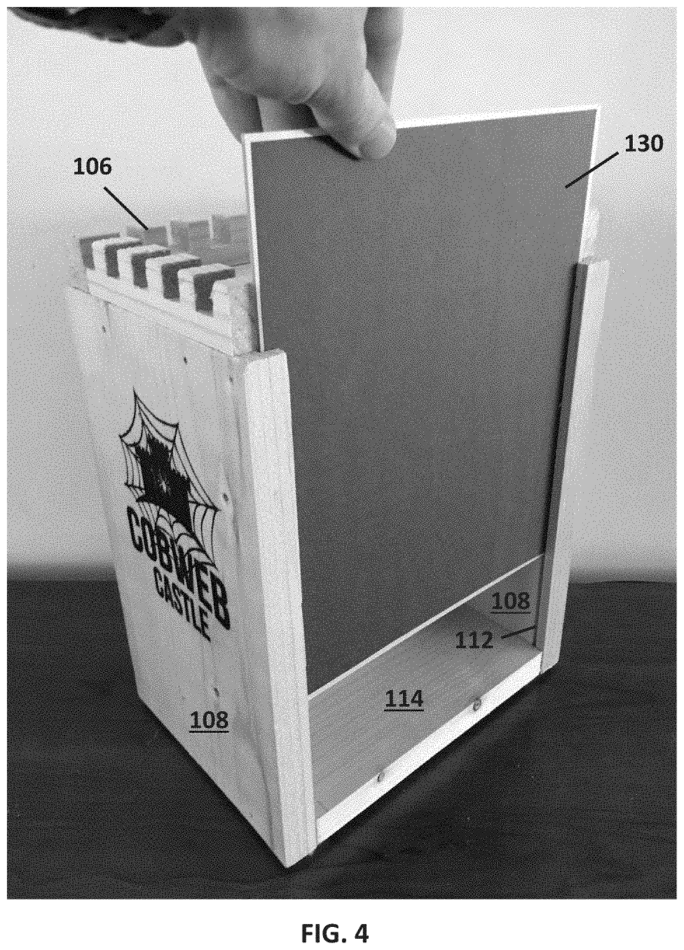

Back grooves 112 are included in the side members and are used to receive an opaque closure 130 in a similar manner to the front grooves receiving the transparent closure. The opaque closure may be slid into the grooves and is biased towards a closed configuration by gravity, but may be manually lifted (as shown in FIG. 4) and removed to allow a user to view the cavity through the transparent member 132. The opaque closure could be formed of any material such as wood, a polymer, cardboard, metal, a composite material, and so forth. Additionally, the opaque closure could have other configurations, such as swinging upon one or more hinges, closing with a latch, secured closed using magnets, and/or any other configuration, similar to what is described above for the transparent closure. A rear bottom groove could be included in the bottom member to receive a bottom of the opaque closure if desired.

The opaque closure is configured to, when closed, darken the second compartment by preventing or greatly reducing light from entering the second compartment. This is useful because it provides an insect or arachnid or other creature a dark location within the cavity. Some species of spiders, for instance, prefer to reside, consume prey, and/or lay eggs in dark locations. When some spiders catch prey they prefer to withdraw into a dark location to consume the prey. Other insects and arachnids and other creatures prefer to reside in dark locations. When the opaque closure is closed it provides such a dark location for the insect/arachnid/creature. On the other hand, when the opaque closure is slid up or removed it allows light into the second compartment and allows the user to view the cavity through the transparent member 132. This is useful in that it allows a user to view the insect or arachnid or other creature within the cavity. For example a user could, by removing the opaque closure, view a spider feeding on prey, resting, preparing an egg sac, and so forth, within the cavity. When the user is done viewing the insect or arachnid or other creature within the cavity the user could replace the opaque closure and slide it into the fully closed configuration so the second compartment is dark again for the insect or arachnid or other creature.

Some additional examples of habitats for arachnids and insects and other creatures are given in Appendices A, B and C of the above mentioned '627 application, the disclosure of each of which is incorporated entirely herein by reference. Appendix A of the '627 application includes the following views of a habitat:

Pg. 2: a front view of a habitat with a transparent closure in a closed configuration, the figure showing a transparent closure, top member, bottom member, side members, and (seen through the transparent closure) a separation member having a through hole;

Pg. 3: a rear view of the habitat with an opaque closure in the closed configuration, the figure showing the opaque closure (formed of a wood panel), top member, side members, and bottom member;

Pg. 4: a rear view of the habitat with the opaque closure removed and showing the top member, side members, bottom member, separation member, a transparent member, screws coupling the transparent member to the separation member, and (through the transparent member) the through hole;

Pg. 5: a side view of the habitat;

Pg. 6: a front/side/top view of the habitat with the transparent closure removed; and

Pg. 7: a front/side/top see-through view of the habitat (with some elements not shown for simplicity).

Appendix B of the '627 application includes the following views of a habitat:

Pg. 2: a front/side/top view of a habitat with a transparent closure removed and including example battlements;

Pg. 3: a front view of the habitat with the transparent closure in the closed configuration, the figure showing the transparent closure, a top member, bottom member, side members, and (seen through the transparent closure) a separation member having a through hole;

Pg. 4: a rear view of the habitat with an opaque closure in the closed configuration, the figure showing the opaque closure (formed of a wood panel), top member, side members, and bottom member;

Pg. 5: a rear view of the habitat with the opaque closure removed and showing the top member, side members, bottom member, separation member, a transparent member, screws coupling the transparent member to the separation member, and (through the transparent member) the through hole;

Pg. 6: a side view of the habitat;

Pg. 7: a front/side/top view of the habitat with the transparent closure removed and without battlements;

Pg. 8: a front/side/top view of the habitat with the transparent closure removed and with battlements shown; and

Pg. 9: a front/side/top see-through view of the habitat (with some elements not shown for simplicity).

In Appendices A and B of the '627 application it is seen that knobs may be included on the transparent closure and/or opaque closure to give the user a location to grab to pull the closures up to remove them and/or to help install them in the closed configuration. They may also be excluded, as seen in FIG. 4.

Appendix C of the '627 application includes other example details for habitats and discusses specific spider species (such as Kukulcania hibernalis) that can be housed using the habitats. Kukulcania hibernalis, for example, prefers to reside in dark cavities and to spread webbing outside the cavity to catch prey—when prey is caught the spider grabs the prey and retreats back into the cavity to feed. The spider shown in the Figures of Appendix C is Kukulcania hibernalis. The habitats could be used to house other species of spiders, however, as well as various species of arachnids, various species of insects, other creatures, and so forth. Another spider species that could be housed in the habitat is Segestria Florentina (a tube spider). Appendix C also discusses details related to the development and use of the habitats.

The habitats could include other aesthetic decorations—such as woodburning on the sides or elsewhere to resemble stones (to enhance the castle-like appearance).

Although any dimensions may be used for different elements/portions of the habitats, some example dimensions are given in Appendices A-C of the '627 application and in other figures and/or description of the '627 application, the '589 application and the '960 application (all measurements and dimensions are given in inches), any of which dimensions may be used for habitats disclosed herein. These are only representative examples, and other dimensions could be used.

In some implementations a habitats could be purchased fully assembled, though in other implementations it could be sold as unassembled or partially-unassembled kit, allowing the user to assemble the kit to form the habitat. For example the user may couple the top member, side members, bottom member, separation member, battlements, transparent member, transparent closure, opaque closure and so forth, together to form the habitat. Such kits could also include items like paint to decorate the habitat to look like a castle or to decorate it in some other way. A spider housed in the habitat could be called a queen, with the habitat being her “castle,” the first compartment being her “keep,” and the cavity being her “lair.”

FIG. 1 shows a collection member 136 at the bottom of the habitat 100. The collection member is used to capture refuse from the habitat so that it can be discarded. For example, spiders will hang off a web to deposit droppings so that the droppings don't get caught in the web. When a spider does this they will fall onto the collection member 136. The collection member can be removed and cleaned or washed to remove the droppings, and then can be replaced again to continue to catch droppings. The collection member can also be used to capture other items such as other insect/arachnid/creature droppings and/or waste, prey remains after feeding, broken sticks, dropped web portions, insect/arachnid/creature molting or shedding or hair/fur, dead hatchlings, used egg sacs, and so forth. The collection tray allows the user to remove these items easily without having to keep the transparent closure open during cleaning and without having to clean/scrub the bottom member 114 (instead only the collection member itself is cleaned/washed, which is convenient as it can be removed and taken to a garbage or sink, for instance, for cleaning). In implementations the collection member could be formed of any material. In the implementation shown in the drawings it is formed of a transparent flat piece of plexiglass. In other implementations it could be formed of wood, metal, a polymer, a glass, a composite material, and so forth. In the implementation shown in the drawings the collection member is fully flat, but in other implementations it could have the shape of a tray, with raised edges around its perimeter, to help prevent items from falling or escaping out of the tray or collection member during collection and/or during cleaning of the collection member.

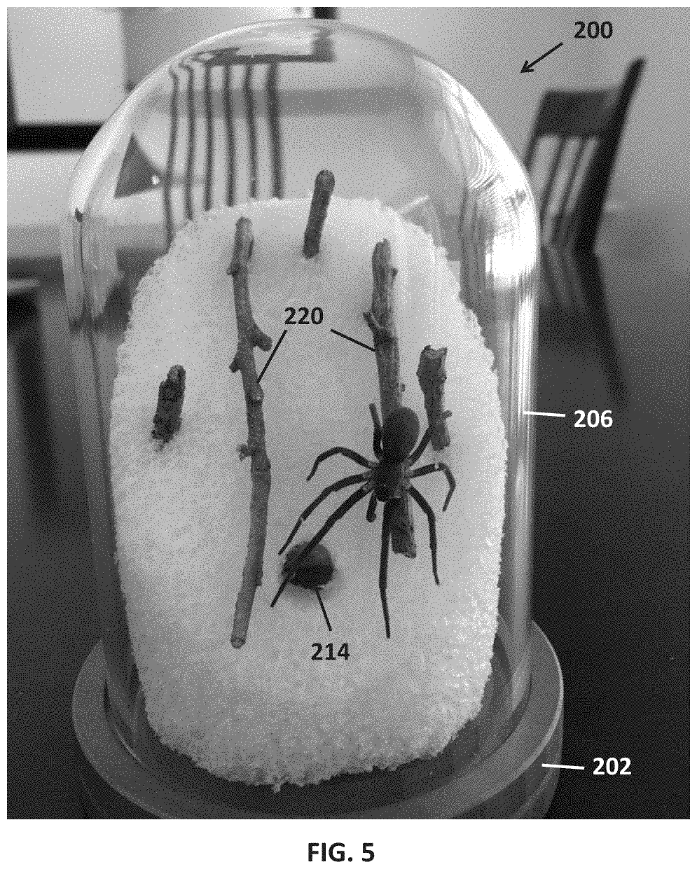

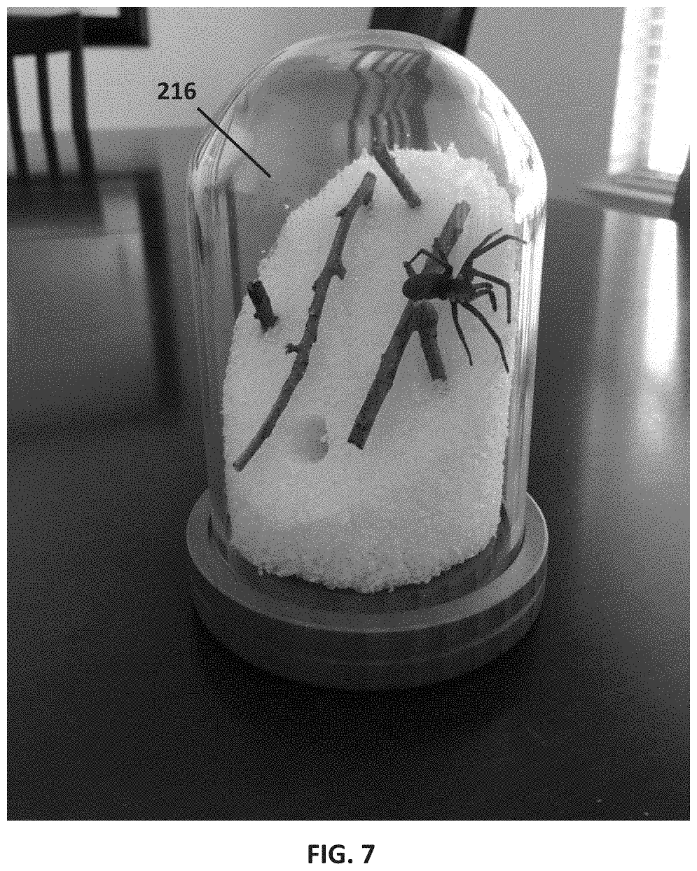

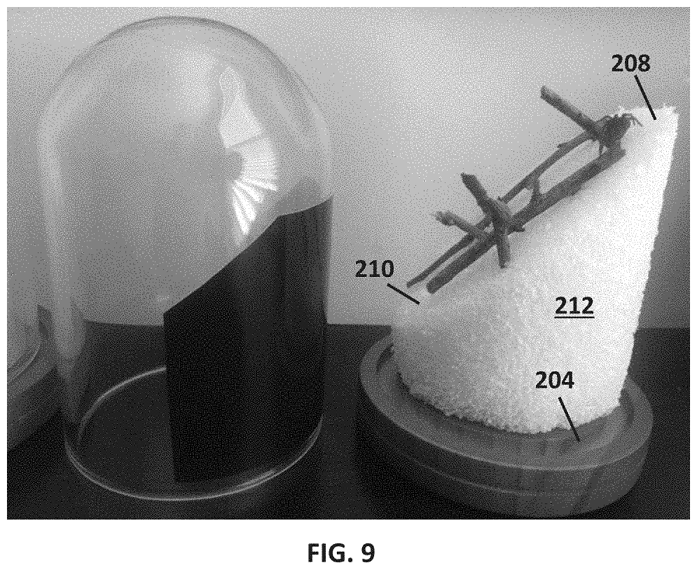

Referring now to FIGS. 5-9, a habitat for living creatures (habitat) 200 is shown. This habitat may be used to house arachnids or insects or other living creatures. Habitat 200 includes a base 202. In the images base 202 is formed of wood but it could alternatively be formed of a polymer or plastic, a metal, a ceramic, a composite, and so forth. The base includes a recess 204 on its upper face. A removable transparent cover is sized to sit within the recess to form an enclosure between the transparent cover and the base. FIG. 9 shows that the recess may be a groove in an upper surface of the base, the groove forming a hollow circle or annulus that is centered in the upper surface of the base (in other words the groove being concentric with the circular upper surface of the base itself). In such a configuration a separation member 208 does not sit within the recess, but atop a portion of the base that is circumscribed by the recess—in other configurations the recess could be a full circle instead of an annulus, and in such configurations the separation member could sit within the recess.

The separation member 208 sits atop the base and within the enclosure, and separates the enclosure into multiple compartments: a first compartment 216 and a second compartment 218. The separation member has a first surface 210. The first compartment is defined by the first surface and by the transparent cover. The separation member has a second surface 212 which is configured to sit close to, or against, the inside surface of the transparent cover. In implementations the second surface 212 does not contact the transparent cover but is close enough to it that an insect or arachnid or other creature within the enclosure cannot fit between the second surface and the transparent cover. This effectively limits the insect or arachnid or other creature to being located within the first compartment, the second compartment, or the through hole 214. The through hole 214 allows the insect or arachnid or other creature to travel between the first compartment and second compartment.

The separation member could be formed of any material. In the drawings it is formed of a polymeric foam. In other implementations it could be formed of a solid polymer, wood, metal, a ceramic, a composite, and so forth.

The separation member could be sized so that the second surface contacts the inner surface of the transparent cover, to further ensure that the insect/arachnid/creature cannot fit between the second surface and the transparent cover. Sizing the separation member so that there is a small gap between the second surface and the inner surface of the transparent cover, however, allows the transparent cover to more easily be removed and then placed back in the enclosed position as desired. This may allow a user to more easily clean the enclosure (such as to remove debris/refuse) and to more easily provide food for the insect or arachnid or other creature, and so forth.

The separation member may have any shape. In the figures it is seen to have a shape of a cylinder cut by a plane, also called a cut cylinder or an inclined cropped cylinder—in this configuration the first surface is the surface created by the plane that cuts the cylinder and the second surface is the sidewall of the cut cylinder. This is just one example, though, and other shapes are possible. Web attachment members 220 are coupled with the first surface such as by glue, nails, screws, staples, a friction fit by being pushed into the foam of the separation member, and so forth. The web attachment members in the drawings are actual sticks, but in implementations they could be artificial sticks and/or could have a non-stick shape/configuration and/or could be formed of a polymer, a metal, a ceramic, a composite, or any other material.

There could also be web attachment members within the through hole and/or within the second compartment, though they are omitted from the through hole and second compartment in the drawings. The web attachment members are elements which an arachnid, such as a spider, may use as attachment points for webs and/or to hold onto while distributing webs (though they may be used in other ways, as described above for other web attachment members). When the habitat is used to house a spider, the web attachment members may allow the spider to attach webs thereon, or may give the spider items to hold onto while stringing webs—the webs used for capturing prey and/or for other reasons.

The through hole provides the insect or arachnid or other creature access to the second compartment. The second compartment is a cavity defined by the separation member and the inner sidewall/surface of the transparent cover. In the implementation shown in the drawings the cavity is also defined by the base, but in other implementations the cavity could be higher up in the separation member so that it is not open to the base on the bottom of the cavity, and so that the cavity is defined only by the separation member and the transparent cover.

An opaque member 222 is coupled with the transparent cover. In the implementations shown in the drawings the opaque member is an opaque sticker that is adhered to an outside of the transparent cover. In other implementations it could be adhered to the inside of the transparent cover. In other implementations it could be an opaque portion of the transparent cover itself, an opaque paint or liquid adhesive (configured to solidify) that is applied to the transparent cover, and so forth. The opaque member may be any color and could be formed of any material and need not be “fully” opaque—in that some visible light may pass through it depending on its thickness, hue and other characteristics. The sticker may be a removable cling sticker that uses surface area or surface energy characteristics to cling to the transparent cover without using an adhesive, or it could be adhered with a relatively weak adhesive that allows easy placement and removal of the sticker, or it could be adhered with a strong or permanent adhesive that allows placement of the sticker but does not allow easy removal (in such cases care must be taken to place the sticker correctly the first time).

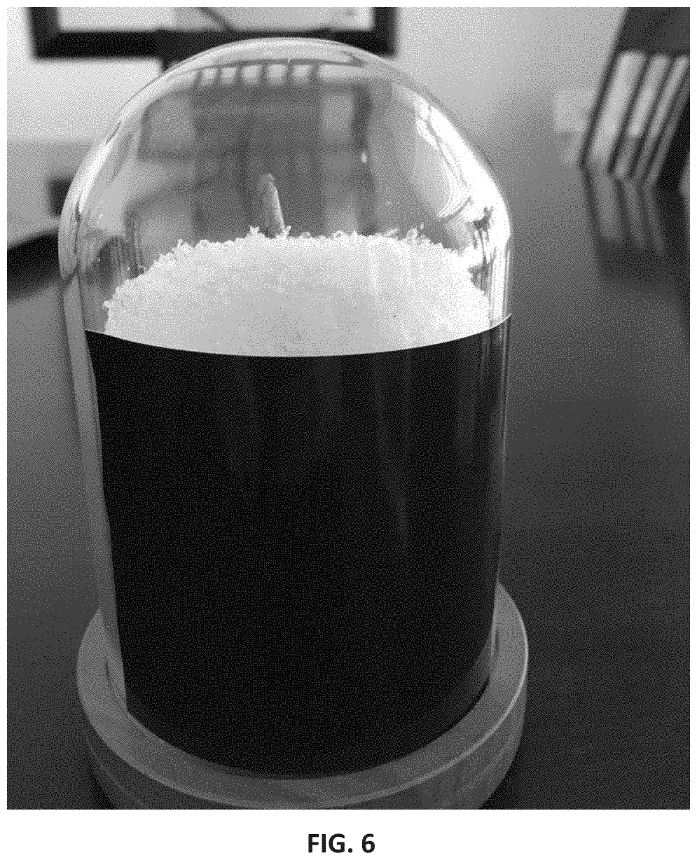

The opaque member is configured to darken the second compartment when the transparent cover is rotated so that the opaque member covers the second compartment (as in FIG. 6), by preventing or greatly reducing the amount of light entering the second compartment. This is useful because it provides an insect or arachnid or other creature a dark location within the enclosure. Some species of spiders, for instance, prefer to reside, consume prey, and/or lay eggs in dark locations. When some spiders catch prey they prefer to withdraw into a dark location to consume the prey. Other insects and arachnids and creatures prefer to reside in dark locations. When the transparent cover is rotated so that the opaque member covers the second compartment it provides such a dark location for the insect/arachnid/creature.

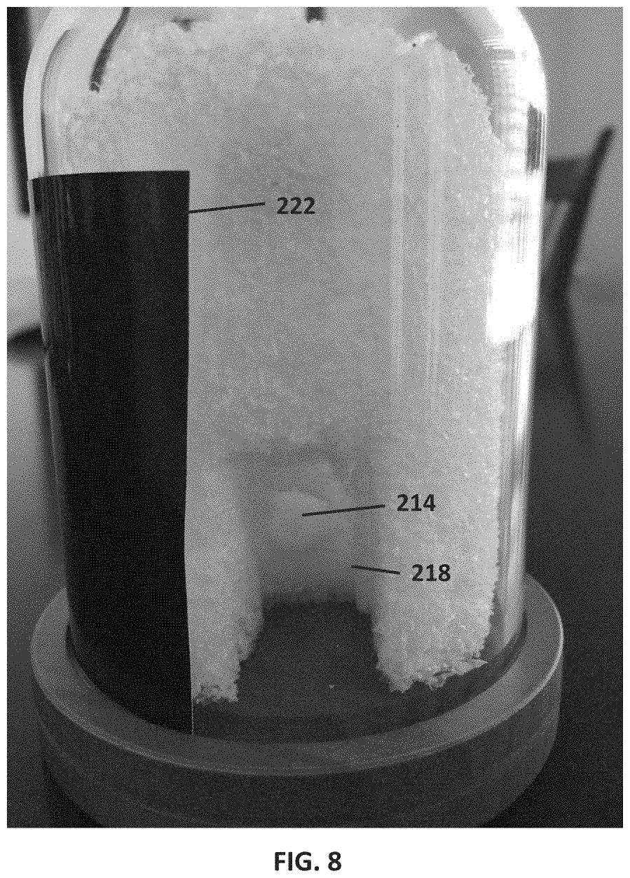

On the other hand, when the transparent cover is rotated so that the opaque member no longer covers the second compartment (as in FIG. 8) this allows light into the second compartment and allows the user to view the second compartment through the transparent cover. This is useful in that it allows a user to view the insect or arachnid or creature within the second compartment. For example a user could, by rotating the transparent cover, view a spider feeding on prey, resting, preparing an egg sac, and so forth, within the second compartment. When the user is done viewing the insect or arachnid or creature within the second compartment the user could rotate the transparent cover so that the second compartment is dark again for the insect or arachnid or creature.

The ability to simply rotate the transparent cover to view the second compartment or darken the compartment, while the transparent cover is sitting within the recess of the base, allows the user to switch between configurations without risking escape of the arachnid/insect/creature. The transparent cover is configured to sit within the recess in such a way that the transparent cover contacts the recess—in other words without any gap between the two sufficient to allow escape of the insect/arachnid/creature.

The transparent cover may be formed of, by non-limiting example, a glass or a transparent polymer—such as a transparent acrylic. In other implementations the transparent cover could be formed of a semi-transparent mesh, such as a metallic mesh formed by metallic wires interwoven or connected so that the mesh includes openings which provide semi-transparency (like a screen door) but which are small enough so that the insect/arachnid/creature (and/or its offspring or prey) cannot escape through the openings. The transparent cover in the drawings is seen to have a shape of a hollow cylinder that is open on the bottom and that is capped with a hollow semi-sphere on top. In other implementations it could have other shapes (for example the top could be capped with a flat circle instead of with a hollow semi-sphere)—though making the lower portion into the shape of an open-bottomed cylinder allows the functionality of easily rotating the transparent cover to switch between viewing the second compartment and darkening the second compartment.

The angled nature of the first surface, and the small gap between the second surface and transparent cover, may allow debris/refuse to fall to the base, allowing the base to effectively act as a collector for collecting droppings, molting or shedding or hair/fur of the arachnid/insect/creature, uneaten portions of prey, discarded remnants of egg sacs, and so forth. The user may remove the transparent cover by lifting it, may lift the separation member (which may not be securely attached to the base), and may thereby clean the base to remove the debris/refuse occasionally. While cleaning the base, the separation member may be placed on a flat surface (such as a table) and the transparent cover placed over it, to keep the insect/arachnid/creature from escaping.

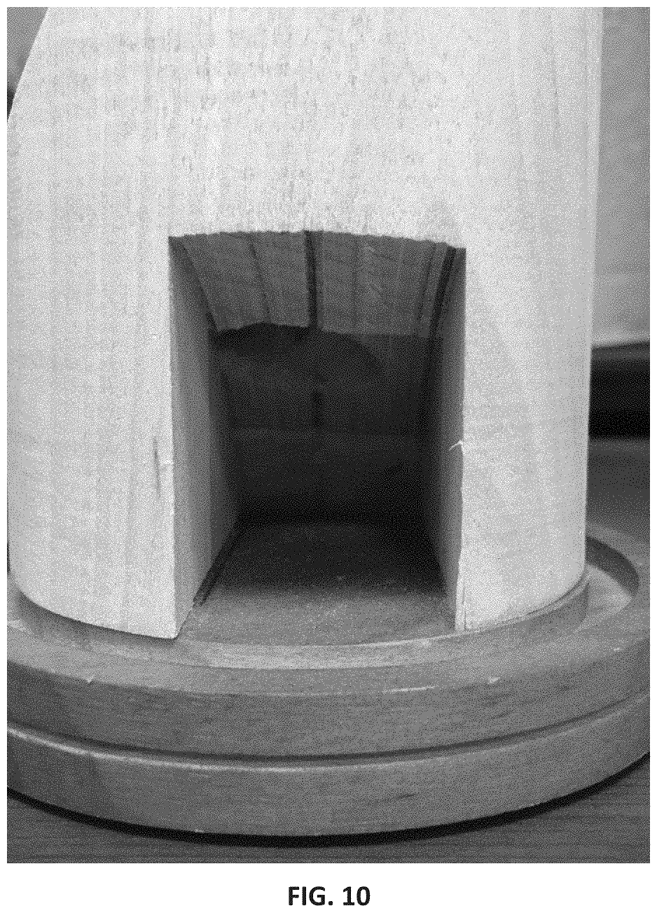

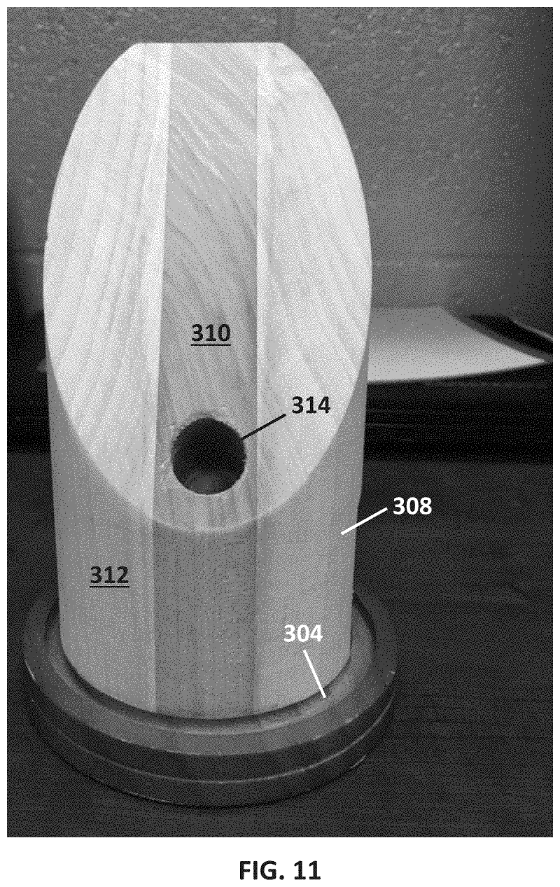

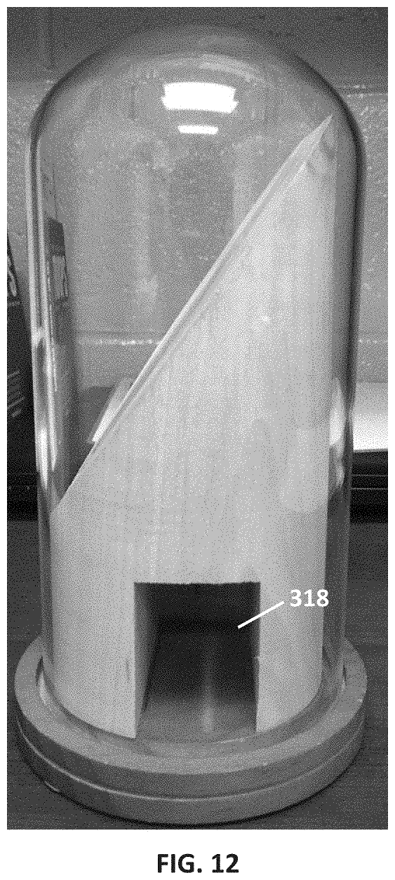

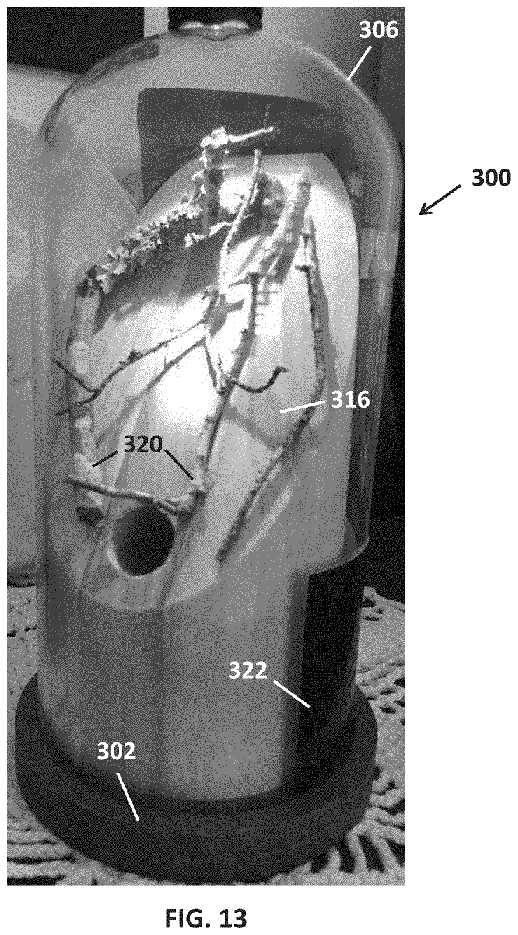

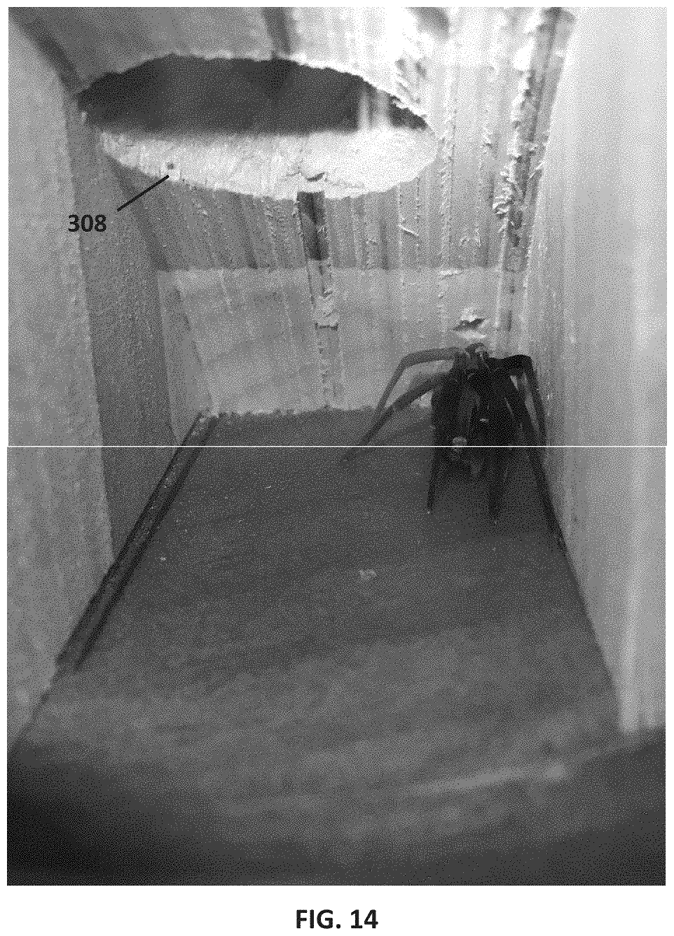

Referring now to FIGS. 10-14, a habitat for living creatures (habitat) 300 is shown. This habitat may be used to house arachnids or insects or other living creatures. Habitat 300 is similar in form and function to habitat 200 except for a few details. Habitat 300 includes a base 302 having a recess 304 in which a transparent cover 306 sits, forming an enclosure between the transparent cover and the base. A separation member 308 sits atop the base and within the enclosure and includes a first surface 310 and second surface 312. The habitat includes a first compartment 316 and a second compartment 318 connected by a through hole 314. Web attachment members 320 are coupled with the separation member. An opaque member 322 is coupled with the transparent cover. Habitat 300 is larger than habitat 200, but each could have any size. The second compartment of habitat 300 is in a different location than the second compartment of habitat 200 and has a somewhat different shape, as seen in the figures. The separation member 308 is formed of wood but in implementations could be formed of any material such as a solid polymer, a polymer foam, a metal, a ceramic, a composite, and so forth. Other details and functions of habitat 300 and its elements are similar to those described above for habitat 200 and its elements, as will be understood by the practitioner of ordinary skill in the art.

Habitats 200 and 300 could be sold as assembled units or as non-assembled kits for the user to assemble, such as allowing the user to attach the web attachment members to the separation member, allowing the user to couple the opaque member with the transparent cover, and so forth. In implementations the separation member may have a shape resembling a castle or portion of a castle, such as including battlements and the like, or having a shape of a fortified tower, and so forth.

In some cases the habitats disclosed herein could be used for creatures other than arachnids and insects, such as small reptiles and other creatures.

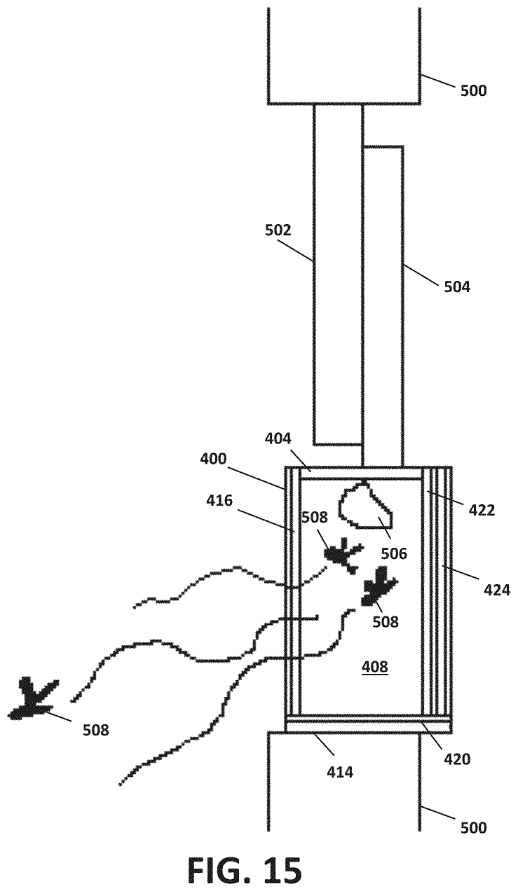

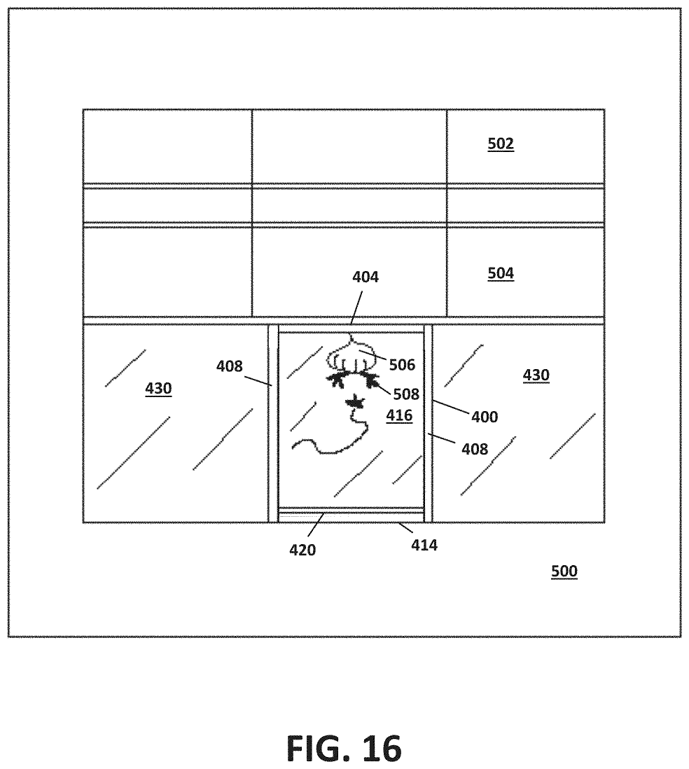

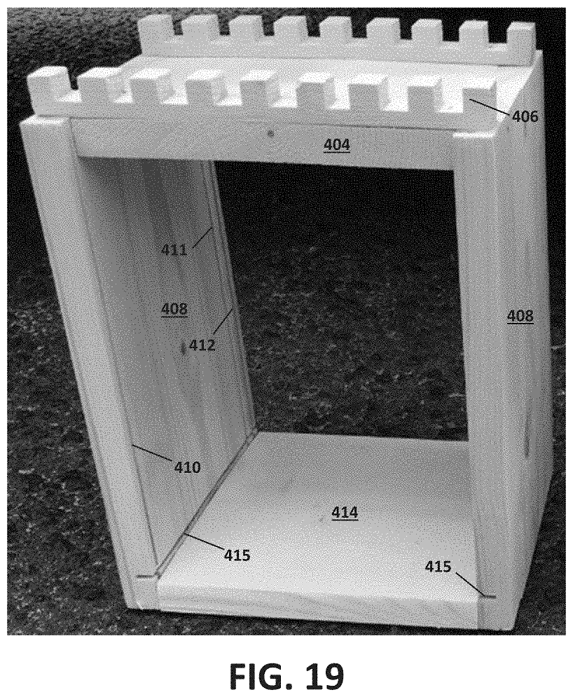

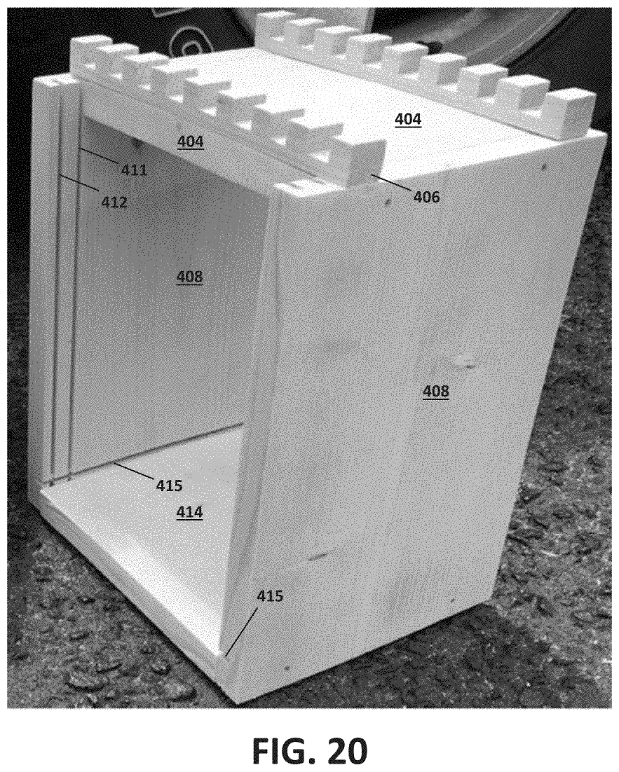

Discussion will now be made related to additional habitats. FIGS. 15-21 show a version of a habitat for living creatures (habitat) 400 (or portions thereof) that is similar in some ways to habitat 100 except that it includes no separation member. There are transparent closures (front transparent closure 416 and rear transparent closure 422) and a rear opaque member 424. FIG. 15 shows a side view (with some elements such as one side member 408 in see-through to show other elements) of the habitat 400 installed in a window and FIG. 16 shows a front view of the habitat installed in a window.

Habitat 400 can be mounted at a window similar to an air conditioning (A/C) unit to provide a habitat for insects and arachnids and other creatures such as spiders, beetles, caterpillars, other crawling insects, wasps, bees, hornets, yellowjackets, butterflies, moths, other creatures, and so forth. If placed low enough to the ground (or close enough to elements allowing creatures to descend from and ascend into the habitat) the habitat could also be used for animals such as frogs, turtles, chipmunks, squirrels, birds, dogs, cats, and so forth. Insects, arachnids, and other living creatures are herein simply referred to as “creatures” for simplicity. As seen in FIGS. 15-16, a lower window portion 504 is slid upwards (relative to an upper window portion 502) to a position to make enough room for receiving the habitat. The habitat is situated in a window that is in an outer wall 500 so the front faces outside the window and outside the house or building. FIG. 15 shows the front transparent closure 416 installed, but it can be removed to allow creatures (such as the example wasps 508 shown in FIG. 15) to enter and exit the habitat as desired. The rear transparent closure 422 and rear opaque member 424 can be removed and installed as desired. The creatures may built a nest or web or the like within the habitat and normally the creatures may have privacy from the rear opaque member, but the rear opaque member can be removed in order to view the creatures, then replaced again to give them privacy. If at any time it is desired to keep the creatures within the habitat for a while, the front transparent closure can be put in place, then later removed to allow the creatures to leave the habitat (by crawling or flying out) and return at will (such as allowing the creatures to leave the habitat to feed and return to sleep/rest at will).

As indicated, FIG. 15 is a side view of the habitat and window/wall elements. FIG. 16 shows an example front view (from outside the house or building). FIG. 16 shows closure members 430 (which in implementations are boards or the like, which can be formed of wood or a polymer or metal or other element). These are placed on the left and right sides to provide a seal between the inside of the house and the outside of the house. When the rear opaque member is removed the creatures can be observed, but the transparent closure at the back prevents the creatures from getting inside the house or building. Although FIGS. 15-16 use an example of wasps 508 which use the habitat to build a wasp hive 506, this is just one example, as the habitats may be used for any flying creatures, not only wasps, and may also be used for non-flying creatures, such as spiders, scorpions, beetles, moths, butterflies, caterpillars, and so forth. FIG. 16 shows an example of three wasps, one flying and two others crawling on a nest the wasps have built. FIGS. 15-16 assume there is no screen present on the window. If there is a screen present, a hole may be cut in the screen to allow the front of the habitat to be open to the outside, and then the closure members may or may not be used, as desired by the user.

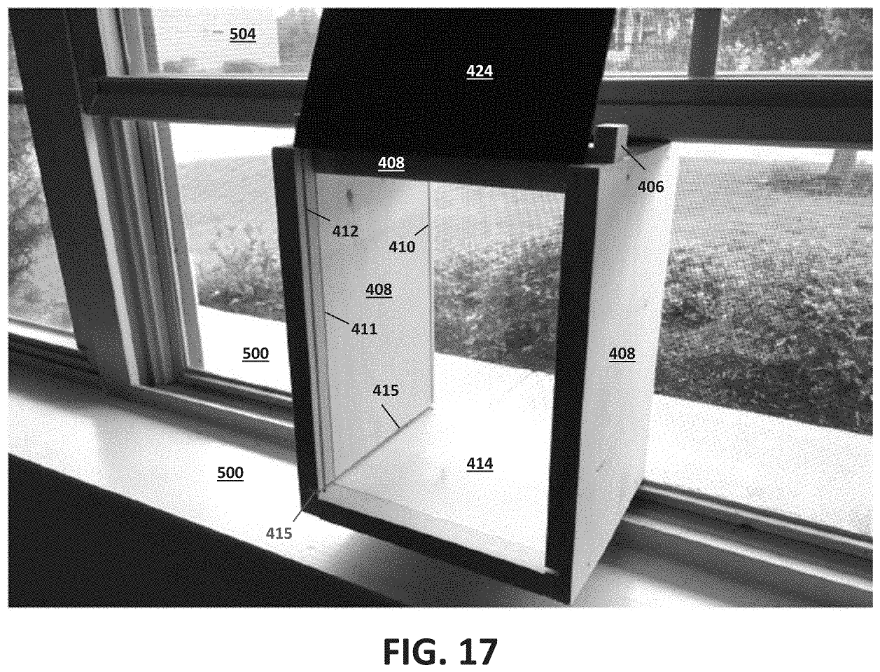

FIGS. 17-21 show various views of portions of the habitat 400. The habitat includes a top member 404, bottom member 414, and side members 408. The inner sides of the side members include front grooves 410 to receive the front transparent closure, first back grooves 411 to receive the rear transparent closure, second back grooves 412 to receive the rear opaque member, and bottom grooves 415 to receive a collection member 420 (which may be removed and re-installed for cleaning refuse from the habitat, as with other habitats disclosed herein). The grooves are sized and positioned, and the transparent closures are sized and shaped, so that the transparent closures in the installed configuration form a close enough seal with the top member, bottom member, and side members so that the creatures cannot escape. The rear opaque member may abut the rear transparent closure (or not), and does not abut the top member because, since the rear transparent closure provides a seal against the creatures escaping into the house or building, the dark or opaque closure does not need to. The “front” of the device faces out of the house or building, through the window. The top, side, and bottom members can be formed of opaque materials such as wood, plastic, metal, a composite, and so forth (and the entire device may come in an unassembled kit for users to assemble, or may come fully assembled). The transparent closures and opaque member may be formed of acrylic or some other material. The collection member 420 may be transparent or not, and may be formed of any of the materials disclosed herein for other collection members. The habitat may include battlements 406 similar to other habitats.

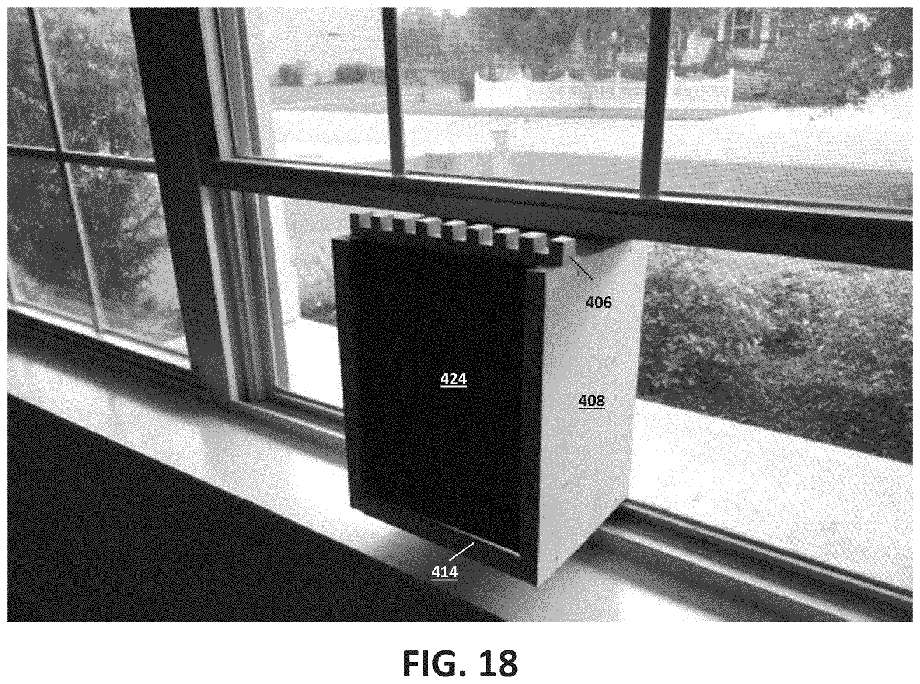

FIG. 17 shows portions of a habitat placed within an open window and the rear opaque member is not yet installed, whereas in FIG. 18 the rear opaque member is installed. As indicated previously, when the rear transparent closure is installed the rear opaque member can be removed without breaking the seal formed by the rear transparent closure, so that the creatures can be viewed through the rear transparent closure without risking the creatures escaping through the rear of the habitat. With the rear opaque member removed the user can view the creatures (including their nest or other items) through the rear transparent closure. In FIG. 15, for example, wasps are inside the closure and can be viewed, along with their wasp hive.

In FIG. 51 the habitat 400 is set up for a spider 432 by including web attachment members 418 for the spider to use as attachment points for a web (though they can also be used for other purposes as with other web attachment members disclosed herein). The web attachment members may be glued or otherwise attached to the top, bottom and/or side members for the spider to use as attachment points for webbing or for the spider to crawl on while creating webbing, and so forth.

In implementations, to set up the habitat 400 for wasps or the like the user could glue or otherwise attach a wasp hive or the like to an inside of the habitat.

As an example of using the habitat 400 for wasps, a user can locate a small wasp nest and carefully remove each of the wasps, such as with a stick, and collect them into a container (for example a sandwich bag). Once all the wasps are secured, the nest can be cut down and then glued to the underside of the top member (or to a side member or bottom member) of the habitat. Once the glue has dried and the device is properly installed into a window opening, the user can carefully release each wasp onto the nest. The wasp and nest contain pheromones that allow the wasps to recognize it as their home. Once the wasps are inside the habitat, the user can safely observe the wasps through the back of the habitat (by removing the rear opaque member) when desired, giving the user a close-up view of wasps that would not otherwise be possible. The wasps are free to go and forage for food and building materials through the removed front transparent closure.

When used with spiders the habitat 400 can be configured by gluing or otherwise attaching sticks or other items around the insides of the members (top, bottom, sides) to be used as web attachment members to encourage a spider to make a web (for example, an orb weaver spider or other spider could be used). In other implementations any other insect or arachnid or creature could be placed within the device. If a spider or other creature placed in the habitat does not need to leave the habitat to forage for food and/or building materials, the user does not need to place the habitat within a window opening. If a spider is placed within the habitat it can be cared for (and the device cleaned, etc.) as disclosed above for other habitats. The habitat allows the user to get a close-up view of the spider or other creature that would not otherwise be possible.

When the habitat is installed through an opening in a window the lower window portion is slid upward enough to allow just enough room to fit the habitat between the bottom of the window frame (or the wall below the frame) and the lower window portion (the lower window portion can be pushed down towards the habitat to create a seal. In FIGS. 17-18 a window screen is present and is covering the front of the habitat, but this will be cut or removed to allow the front of the habitat to be open to the outside. The front grooves, first back grooves, and second back grooves can clearly be seen in FIGS. 17 and 19-21. The bottom grooves at or proximate the bottoms of the side members allow the collection member (transparent or otherwise) to be slid therein. This collection member can be used to collect droppings and refuse and the like of the creatures so that the collection member can be removed and cleaned without dirtying the bottom member of the habitat (since the collection member covers the bottom member generally).

When the collection member is used the front and rear transparent closures when installed may abut the collection member to create seals at the bottom front and rear of the habitat to prevent the creatures from escaping therethrough. When the collection member is used the rear opaque member when installed may also abut the collection member. The collection member in implementations may be made of the same material as the transparent closures (such as glass or clear acrylic) and may be in that sense identical to the transparent closures except sized differently to fit in a way so as to just perfectly (or nearly perfectly) cover the bottom member. In some implementations the collection member is sized so that it fits (snugly or nearly snugly, or loosely) between the front and rear transparent closures so that the collection member rests within the bottom grooves and atop the bottom member while also sitting between the installed front and rear transparent closures. In such implementations the front and rear transparent closures and the rear opaque member would sit directly atop the bottom member of the habitat. In implementations the collection member could be formed of the same material as the rear opaque member, but sized to an appropriate size to be used to cover the bottom member (or a portion thereof).

In FIG. 17 the rear opaque member is about to be slid into the second back grooves. FIG. 18 shows the habitat with the rear opaque member slid to the fully installed configuration in the second back grooves.

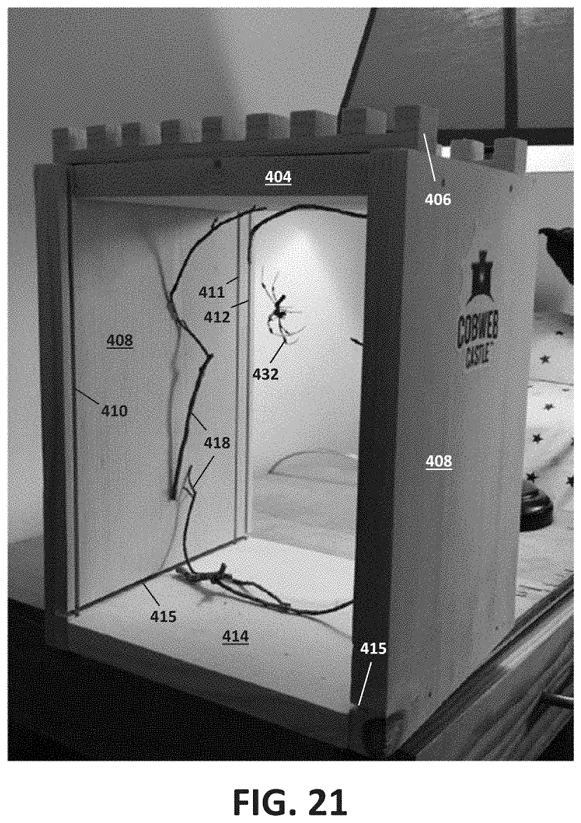

In FIG. 21 the transparent closures and rear opaque member are not installed (nor is the collection member installed) but web attachment members are installed (which in this implementation are sticks), and a spider has formed webs within the habitat (and/or on/between the web attachment members) and is hanging from some of the webs. In implementations the web attachment members at the bottom of the habitat could be attached to the collection member (such as with glue or the like) or the web attachment members could only be attached to the side and top members, in either case to allow the collection member to be easily installed and removed for cleaning and removal of refuse, droppings, shedding, old egg sacs, used/dead prey, sheddings/molting, fur/hairs, and the like from the habitat. The spider shown in FIG. 21 is a juvenile golden silk orb weaver, but this is only one example of a spider or insect/arachnid/creature that could be kept within the habitat.

Any of the habitats disclosed herein could be used for insects, arachnids, flying creatures/insects, crawling creatures/insects, non-insect creatures, small mammals, reptiles, and so forth. Any of the habitats could be installed in window openings or used in a location other than a window opening.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of habitats for living creatures and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order—such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A habit for living creatures, comprising:
a top member;
a plurality of side members coupled with the top member;
a bottom member coupled with the side members;
a separation member separating the habitat into a first compartment and a second compartment;
a through hole providing access between the first compartment and second compartment; and
an opaque member selectively preventing light from entering the second compartment.
